(19) United States
(12) Patent Application Publication
(10) Pub. No.: US 2021/0235606 A1
(43) Pub. Date: Aug. 5, 2021

(54) Combination Shovel/Pick Assembly

(71) Applicant: Ned Hyduke, Blythe, CA (US)

(72) Inventor: Ned Hyduke, Blythe, CA (US)

(21) Appl. No.: 16/777,417

(22) Filed: Jan. 30, 2020

(51) Int. Cl. A01B 1/02; B25G 1/10; A01B 1/20; B25F 1/00

(52) U.S. Cl. CPC A01B 1/022; B25F 1/00; A01B 1/20; B25G 1/102

(57) ABSTRACT

A combination shovel/pick assembly for shovel or picking includes a handle that is longitudinally elongate. The handle has a plurality of finger valleys each integrated into the handle to receive a respective user's fingers for enhancing gripping the handle. A shovel head is coupled to the handle for shoveling loose material. A pick is coupled to the handle to break apart solid material and the pick is positioned on an opposite end of the handle from the shovel head.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to shovel/pick devices and more particularly pertains to a new shovel/pick device for shoveling or picking.

### (2) Description of Related Art Including Information Disclosed Under 37 CFR 1.97 and 1.98

The prior art relates to shovel/pick devices. The prior art discloses a shovel/pick assembly that includes a foldable shovel head and a pick that extends along a transverse axis with respect to a handle. Additionally, the prior art discloses a modular shovel/pick assembly. The prior art discloses a shovel head attachment for an ice climbing axe and the prior art discloses a multi-purpose tool that can be assembled into a variety of configurations. The prior art also discloses a multipurpose tool that includes a plurality of interchangeable tool attachments.

### BRIEF SUMMARY OF THE INVENTION

An embodiment of the disclosure meets the needs presented above by generally comprising a handle that is longitudinally elongate. The handle has a plurality of finger valleys each integrated into the handle to receive a respective user's fingers for enhancing gripping the handle. A shovel head is coupled to the handle for shoveling loose material. A pick is coupled to the handle to break apart solid material and the pick is positioned on an opposite end of the handle from the shovel head.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of a combination shovel/pick assembly according to an embodiment of the disclosure.

FIG. 2 is a bottom perspective view of an embodiment of the disclosure.

FIG. 3 is a bottom view of an embodiment of the disclosure.

FIG. 4 is a top view of an embodiment of the disclosure.

FIG. 5 is a right side view of an embodiment of the disclosure.

### DETAILED DESCRIPTION OF THE INVENTION

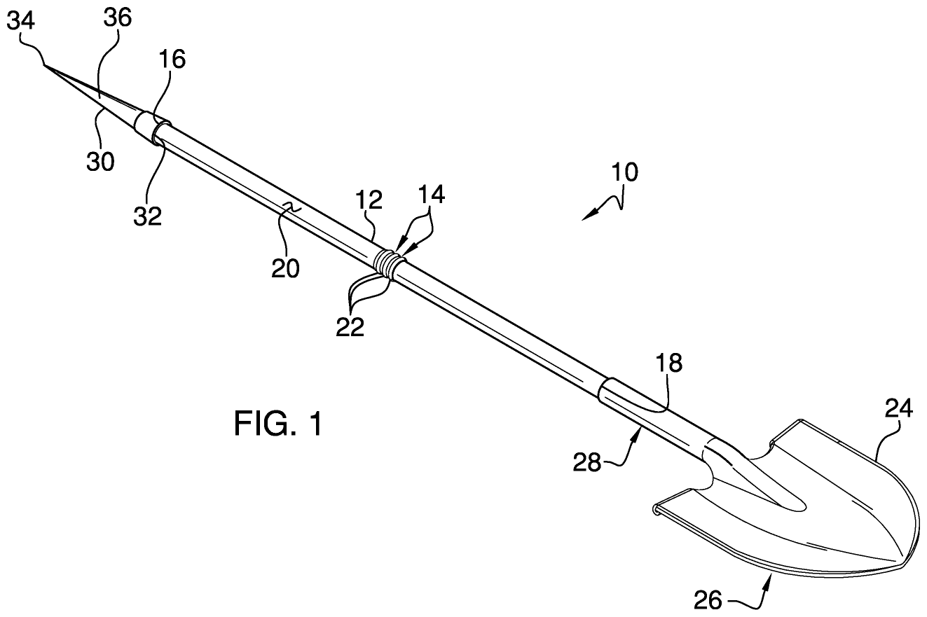

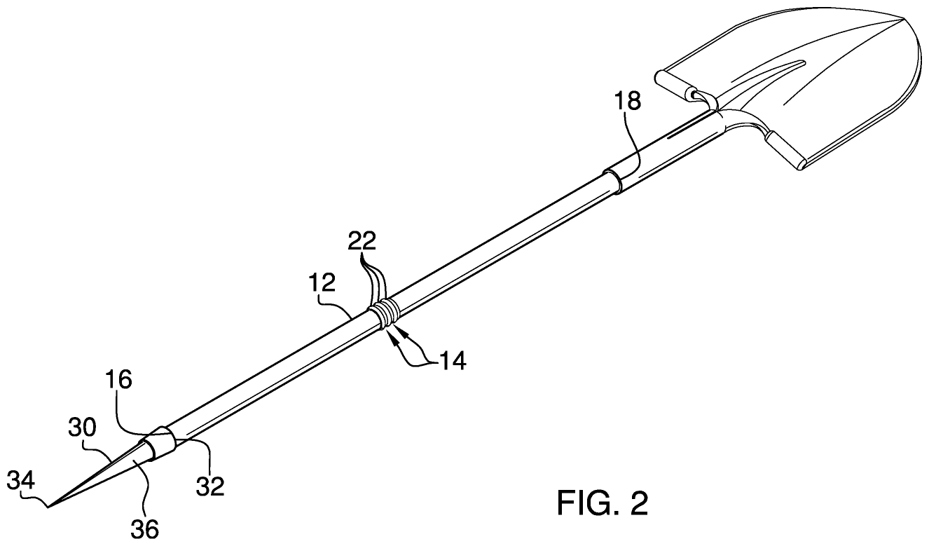

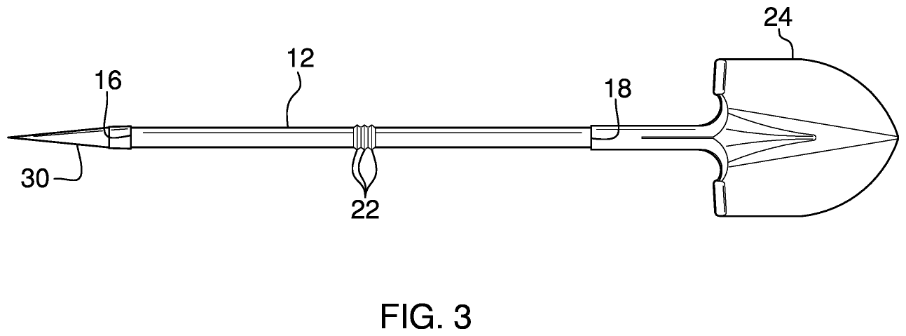

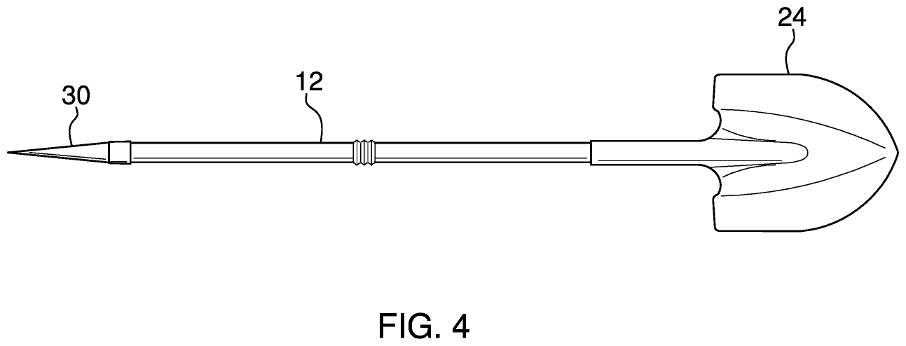

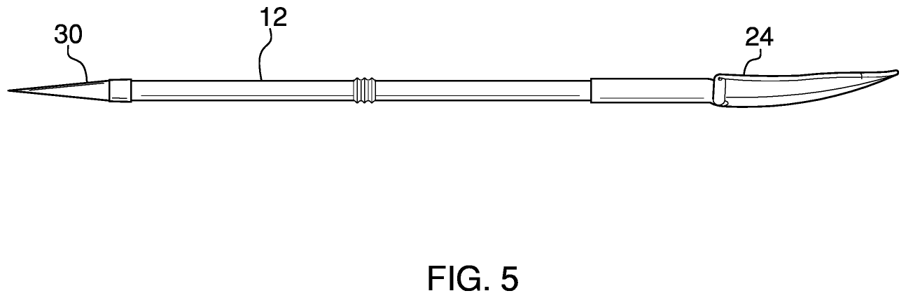

With reference now to the drawings, and in particular to FIGS. 1 through 5 thereof, a new shovel/pick device embodying the principles and concepts of an embodiment of the disclosure and generally designated by the reference numeral 10 will be described.

As best illustrated in FIGS. 1 through 5, the combination shovel/pick assembly 10 generally comprises a handle 12 that is longitudinally elongate to a length of at least 30.0 inches. The handle 12 may be comprised of a rigid material such as wood, plastic, fiberglass or other material commonly used to construct tool handles. The handle 12 has a plurality of finger valleys 14 that is each integrated into the handle 12. Moreover, each of the finger valleys 14 receives a respective user's fingers for enhancing gripping the handle 12.

The handle 12 has a pick end 16, a shovel end 18 and an outer surface 20 extending therebetween, and the handle 12 is elongated between the pick end 16 and the shovel end 18. The outer surface 20 has a plurality of ridges 22 each extending around an entire circumference of the outer surface 20. The ridges 22 are spaced apart from each other to define each of the finger valleys 14 between respective pairs of the ridges 22. Additionally, the plurality of ridges 22 is positioned closer to the shovel end 18 than the pick end 16 of the handle 12.

A shovel head 24 is provided and the shovel head 24 is coupled to the handle 12 for shoveling loose material, such as dirt, gravel, sand or other similar material. The shovel has a blade 26 and a socket 28, and the socket 28 insertably receives the shovel end 18 of the handle 12. Additionally, the blade 26 extends along an axis extending through the pick end 16 and the shovel end 18 of the handle 12. The shovel head 24 may have a length of at least 20.0 inches and a width of at least 8.0 inches. Additionally, the shovel head 24 may taper to a point in the same manner as a dirt shovel or sand shovel.

A pick 30 is coupled to the handle 12 to break apart solid material, such as fractured rocks, compacted sediment or other similar material that cannot be shoveled. The pick 30 is positioned on an opposite end of the handle 12 from the shovel head 24. The pick 30 has a coupled end 32, a free end 34 and an outer wall 36 extending therebetween. The outer wall 36 tapers to a point between the coupled end 32 and the free end 34 to pierce the solid material. The coupled end 32 is open and the coupled end 32 insertably receives the pick end 16 of the handle 12. Additionally, the pick 30 may have a length of at least 8.0 inches.

In use, the handle 12 is gripped with the shovel head 24 being directed toward the ground thereby facilitating the shovel head 24 to shovel the loose material. Additionally, the finger valleys in the handle 12 inhibit the user's hand from sliding along the handle 12 while the loose material is being shoveled. The handle 12 is flipped around such that the pick 30 is directed toward the ground when solid material is encountered. In this way the solid material can be broken apart to facilitate the solid material to be shoveled.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A combination shovel/pick assembly being configured to shovel loose material and break apart rock, said assembly comprising:
a handle being longitudinally elongate, said handle having a plurality of finger valleys each being integrated into said handle wherein each of said finger valleys is configured to receive a respective user's fingers for enhancing gripping said handle;
a shovel head being coupled to said handle wherein said shovel head is configured to shovel loose material; and
a pick being coupled to said handle wherein said pick is configured to break apart solid material, said pick being positioned on an opposite end of said handle from said shovel head.

2. The assembly according to claim 1, wherein said handle has a pick end, a shovel end and an outer surface extending therebetween, said handle being elongated between said pick end and said shovel end, said outer surface having a plurality of ridges each extending around an entire circumference of said outer surface.

3. The assembly according to claim 2, wherein said ridges are spaced apart from each other to define each of said valleys between respective pairs of said ridges, said plurality of ridges being positioned closer to said shovel end than said pick end of said handle.

4. The assembly according to claim 2, wherein said shovel has a blade and a socket, said socket insertably receiving said shovel end of said handle such that said blade extends along an axis extending through said pick end and said shovel end of said handle.

5. The assembly according to claim 2, wherein said pick has a coupled end, a free end and an outer wall extending therebetween, said outer wall tapering to a point between said coupled end and said free end wherein said free end is configured to pierce the solid material, said coupled end being open, said coupled end insertably receiving said pick end of said handle.

6. A combination shovel/pick assembly being configured to shovel loose material and break apart rock, said assembly comprising:
a handle being longitudinally elongate, said handle having a plurality of finger valleys each being integrated into said handle wherein each of said finger valleys is configured to receive a respective user's fingers for enhancing gripping said handle, said handle having a pick end, a shovel end and an outer surface extending therebetween, said handle being elongated between said pick end and said shovel end, said outer surface having a plurality of ridges each extending around an entire circumference of said outer surface, said ridges being spaced apart from each other to define each of said valleys between respective pairs of said ridges, said plurality of ridges being positioned closer to said shovel end than said pick end of said handle;
a shovel head being coupled to said handle wherein said shovel head is configured to shovel loose material, said shovel having a blade and a socket, said socket insertably receiving said shovel end of said handle such that said blade extends along an axis extending through said pick end and said shovel end of said handle; and
a pick being coupled to said handle wherein said pick is configured to break apart solid material, said pick being positioned on an opposite end of said handle from said shovel head, said pick having a coupled end, a free end and an outer wall extending therebetween, said outer wall tapering to a point between said coupled end and said free end wherein said free end is configured to pierce the solid material, said coupled end being open, said coupled end insertably receiving said pick end of said handle.
